(19) United States
(12) Patent Application Publication
(10) Pub. No.: US 2007/0204295 A1
(43) Pub. Date: Aug. 30, 2007

(54) Digital broadcast receiver

(75) Inventors: Masakazu Kobayashi, Echizen-city (JP); Ryouichi Morishita, Echizen-city (JP); Atsushi Kakiuchi, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/709,244

(22) Filed: Feb. 22, 2007

(30) Foreign Application Priority Data
Feb. 24, 2006 (JP) 2006-048121

(51) Int. Cl. H04N 5/445

(52) U.S. Cl. 725/38

(57) ABSTRACT

Disclosed herein is a digital broadcast receiver capable of performing synthesis on a commercial that a user desires. If the commercial satisfies the Jth condition, a synthesis unit reads image data assigned to the Jth condition from a storage unit. Further, if a sync signal has been detected, the synthesis unit synthesizes an image represented by the image data read from the storage unit with video represented by a video signal outputted from a decoder, and outputs the synthesized data.

The present application is based on and claims priority of Japanese patent application No. 2006-048121 filed on Feb. 24, 2006, the entire contents of which are hereby incorporated by reference.

### BACKGROUND OF THE INVENTION

1. Field of the Invention

The present invention relates to a digital broadcast receiver, and more particularly, to a digital broadcast receiver for receiving digital broadcasts transmitted from broadcast stations over the airwaves and a digital broadcast receiver for receiving digital broadcasts transmitted from servers via the Internet.

2. Description of the Related Art

There are needs that users want to synthesize an image with a part of the video of a received digital broadcast to enjoy the synthesized video. If image synthesis is performed on a program proper (e.g., a drama or news), its content may become difficult to understand; therefore, there are strong needs for image synthesis performed on a commercial. Some commercials allow a user to feel as if the user were involved in them by replacing a part of the video. For example, if a photograph of a character's face in a commercial is replaced by a photograph of the user's face, the user can feel as if the user were a main character in the commercial.

Achieving this requires a technique for synthesizing images. That is, there is required a technique for synthesizing an image with original video shown in FIG. 13A, as shown in FIG. 13B. Such a technique is disclosed in Japanese Patent Laid-Open Publication Nos. 6-253232, 6-295339, and 7-95493 (patent documents 1, 2, and 3).

However, none of the techniques disclosed in patent documents 1, 2, and 3 makes it possible to designate a commercial for synthesis so that it is difficult to perform synthesis only on a commercial that a user desires.

### SUMMARY OF THE INVENTION

The present invention has been made in view of the above circumstance, and it is an object of the invention to provide, by designating a commercial for synthesis, a digital broadcast receiver capable of performing synthesis on a commercial that a user desires.

A first aspect of the invention relates to a digital broadcast receiver including a receiving unit for receiving a digital signal sequence which is data of content transmitted by a digital broadcast; a decoder for decoding the received digital signal sequence into content information, an audio signal, and a video signal; a storage unit for storing image data; a synthesis unit for reading image data stored in the storage unit and synthesizing an image represented by the image data with video represented by the video signal; and a controller for controlling the receiving unit, the decoder, the storage unit, and the synthesis unit; wherein the storage unit further stores a condition for determining whether the transmitted content is a commercial with which an image is synthesized and information for designating image data assigned for each condition; the controller determines whether the transmitted content satisfies a condition stored in the storage unit; and if the controller determines that the transmitted content satisfies at least one of conditions stored in the storage unit, the synthesis unit reads from the storage unit image data designated by information for designating image data assigned for a satisfied condition stored in the storage unit and synthesizes an image represented by the image data with video represented by the video signal.

The digital broadcast receiver of the first aspect can synthesize an image with a commercial that satisfies a preset condition.

A second aspect of the invention relates to the digital broadcast receiver of the first aspect, wherein the controller uses the content information to determine whether the transmitted content satisfies a condition stored in the storage unit.

The digital broadcast receiver of the second aspect can synthesize an image with a commercial that satisfies a condition by determining a preset condition using content information.

A third aspect of the invention relates to the digital broadcast receiver of the first or second aspect, wherein the controller detects a sync signal from the received digital signal sequence; and if the controller determines that the transmitted content satisfies at least one of conditions stored in the storage unit, the synthesis unit reads from the storage unit image data designated by information for designating image data assigned for a satisfied condition stored in the storage unit and synthesizes an image represented by the image data with video represented by the video signal only during a period determined based on the sync signal.

The digital broadcast receiver of the third aspect can synthesize an image with a commercial that satisfies a preset condition, based on a sync signal.

A fourth aspect of the invention relates to the digital broadcast receiver of the first or second aspect, wherein the controller detects a sync signal from the received digital signal sequence; and if the controller determines that the transmitted content satisfies at least one of conditions stored in the storage unit, the synthesis unit reads from the storage unit image data designated by information for designating image data assigned for a satisfied condition stored in the storage unit and synthesizes an image represented by the image data with video represented by the video signal only during a period over which the controller detects the sync signal.

The digital broadcast receiver of the fourth aspect can synthesize an image with a commercial that satisfies a preset condition, only during a period over which sync signals are detected.

A fifth aspect of the invention relates to the digital broadcast receiver of any one of the first to fourth aspects, wherein the condition designates a company advertised in a commercial, a category of content, and a broadcast time.

The digital broadcast receiver of the fifth aspect can synthesize an image with a commercial that satisfies a preset condition concerning a company advertised, a category of content, and a broadcast time.

### BRIEF DESCRIPTION OF THE DRAWINGS

An embodiment of the present invention will be described in detail based on the following figures, wherein:

FIG. 1 is a block diagram showing the configuration of an embodiment of the present invention;

FIG. 2 is an explanatory view showing a remote control according to the embodiment of the invention;

FIG. 3 is an explanatory view showing an operation screen according to the embodiment of the invention;

FIG. 4 is an explanatory view showing an operation screen according to the embodiment of the invention;

FIG. 5 is an explanatory view showing an operation screen according to the embodiment of the invention;

FIG. 6 is an explanatory view showing an operation screen according to the embodiment of the invention;

FIG. 7 is an explanatory view showing an operation screen according to the embodiment of the invention;

FIG. 8 is an explanatory view showing an operation screen according to the embodiment of the invention;

FIG. 9 is an explanatory view showing an operation screen according to the embodiment of the invention;

FIG. 10 is an explanatory view showing an operation screen according to the embodiment of the invention;

FIG. 11 is an explanatory view showing an operation screen according to the embodiment of the invention;

FIG. 12 is a flowchart showing the flow of processing according to the embodiment of the invention; and

FIGS. 13A and 13B are explanatory views illustrating the state of a synthesized image.

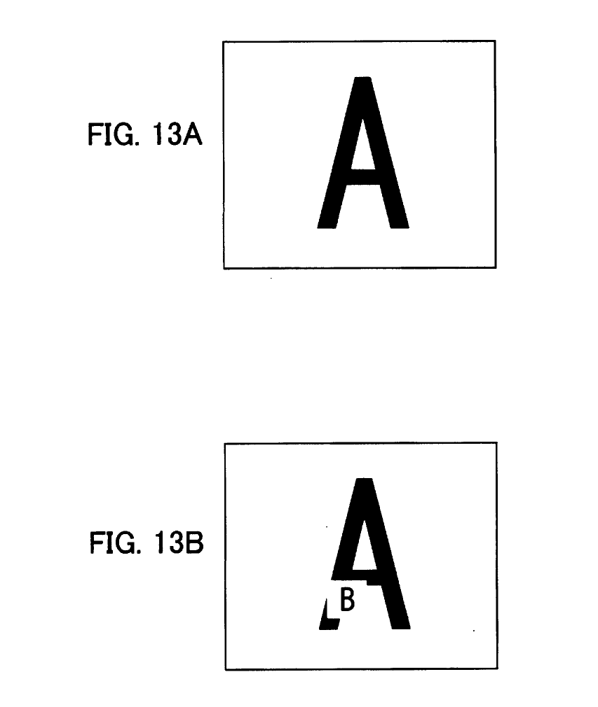

### DESCRIPTION OF THE PREFERRED EMBODIMENT

An embodiment of the present invention will be described with reference to the accompanying drawings. The following examples are merely specific examples of the invention, and the invention is not limited thereto.

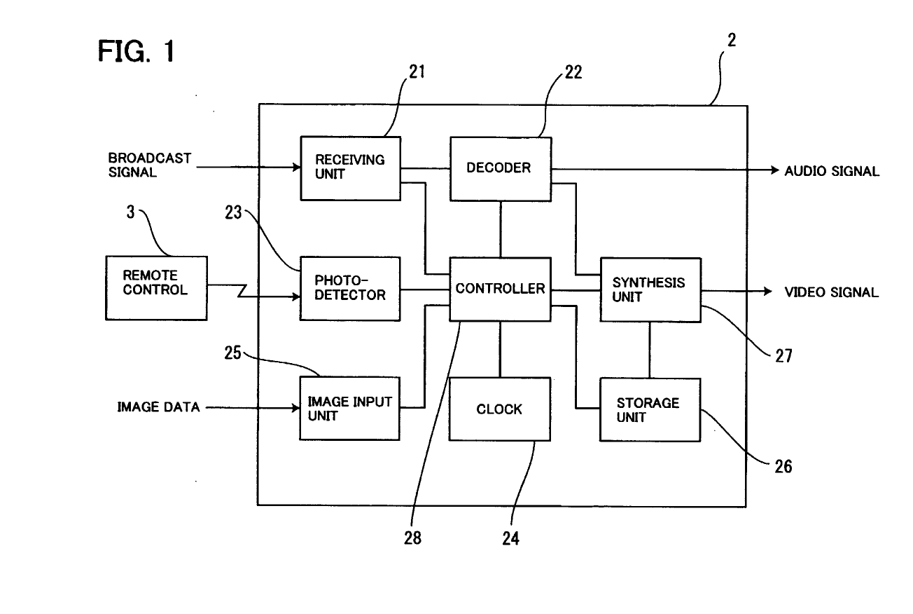

FIG. 1 is a block diagram showing the configuration of a digital broadcast receiver according to this embodiment. A digital broadcast receiver 2 according to this embodiment includes a receiving unit 21, a decoder 22, a photodetector 23, a clock 24, an image input unit 25, a storage unit 26, a synthesis unit 27, and a controller 28.

The receiving unit 21 receives a digital signal sequence which is data of content transmitted by a digital broadcast. The decoder 22 decodes the received digital signal sequence into content information, an audio signal, and a video signal. The photodetector 23 receives a control signal transmitted from a remote control 3. The clock 24 counts times. The image input unit 25 is used at the time of inputting the image data of an image to be used for synthesis. The storage unit 26 stores image data inputted through the image input unit 25, a condition for determining whether the transmitted content is a commercial with which an image is synthesized, and information for designating image data assigned for each condition. The synthesis unit 27 reads image data stored beforehand in the storage unit 26 and synthesizes an image represented by the image data with video represented by a video signal outputted from the decoder 22. The controller 28 controls each unit of the digital broadcast receiver 2 and detects a sync signal.

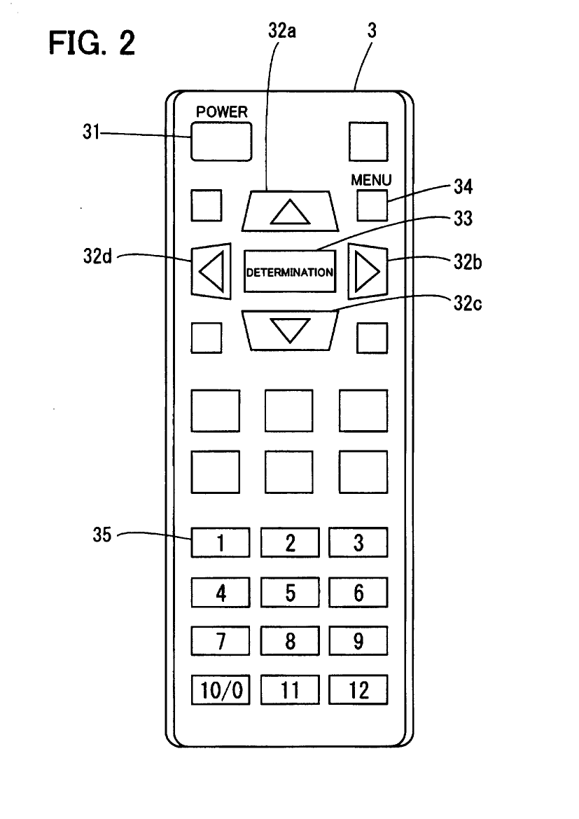

FIG. 2 is an illustration showing the remote control 3. When a menu key 34 is depressed, a menu is displayed. Direction keys (an up key 32a, a right key 32b, a down key 32c, and a left key 32d) move a cursor in the depressed direction and move a selection portion. When a determination key 33 is depressed, an item or a state selected at that point in time is determined. When a ten key 35 is depressed, a number corresponding to the depressed key is inputted. A power key 31 turns on and off the digital broadcast receiver 2. A user inputs beforehand the image data of an image to be used for synthesis, using the image input unit 25. Further, the user inputs beforehand a condition for determining whether transmitted content is a commercial with which the image is synthesized, using the remote control 3. The inputted image data and condition are stored in the storage unit 26. Furthermore, the user designates beforehand image data assigned for each condition, using the remote control 3. Information for designating the image data assigned for each condition is stored in the storage unit 26.

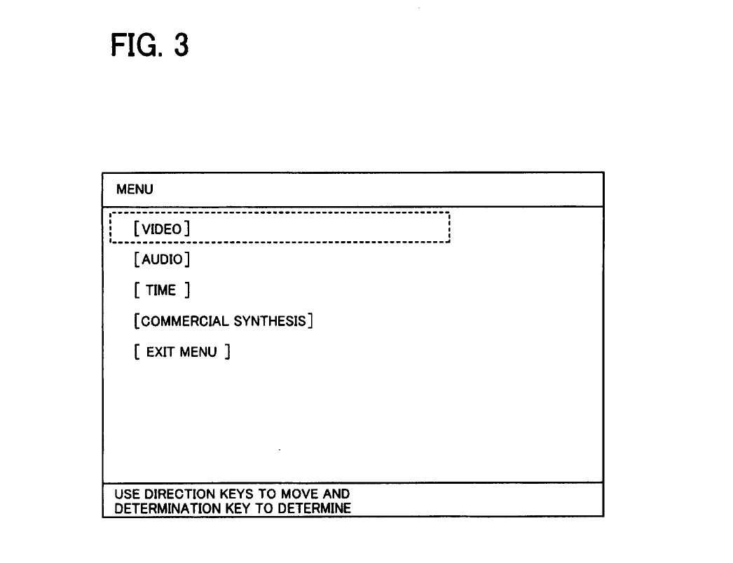

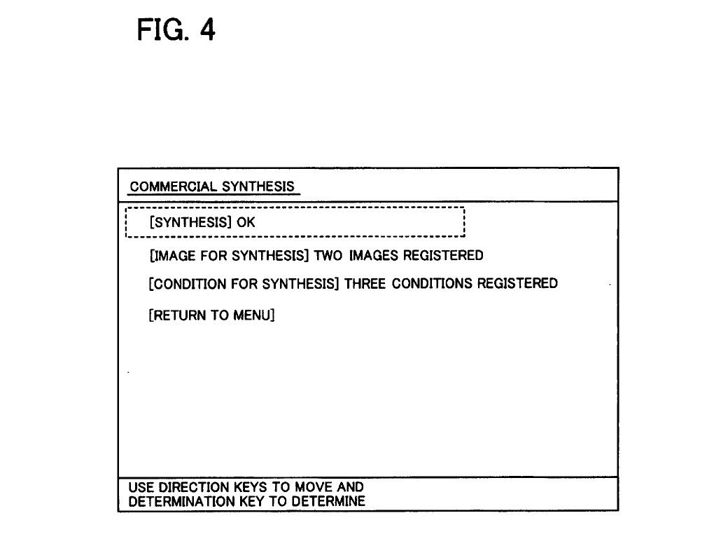

FIGS. 3 to 11 are explanatory views showing operation screens on which the above-described presets are performed. First, when the menu key 34 on the remote control 3 is depressed, an operation screen shown in FIG. 3 is displayed. Next, the cursor is moved by using the direction keys 32a and 32c, and an item is determined by depressing the determination key 33. When the cursor is moved to “COMMERCIAL SYNTHESIS” and the determination key 33 is depressed, an operation screen shown in FIG. 4 is displayed.

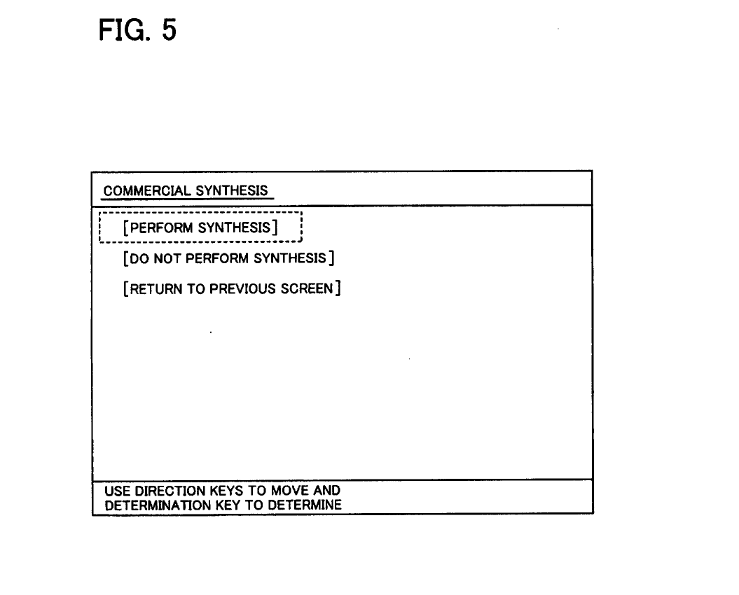

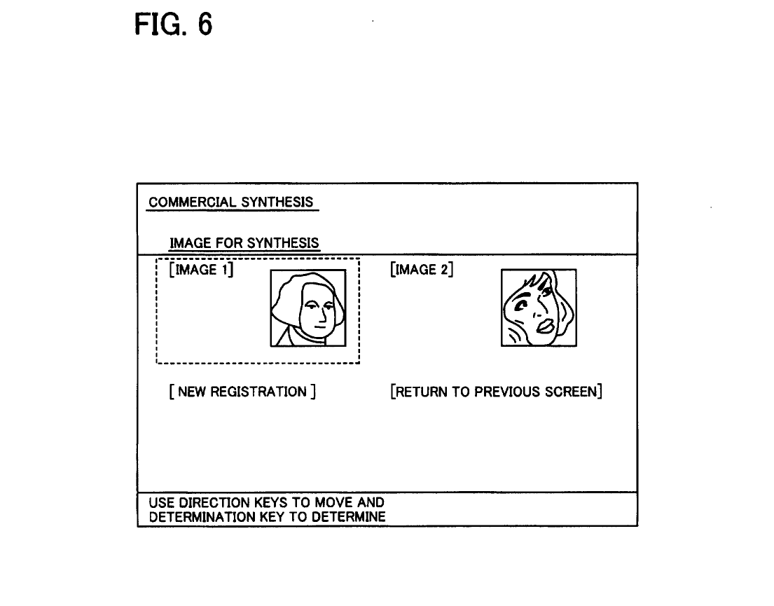

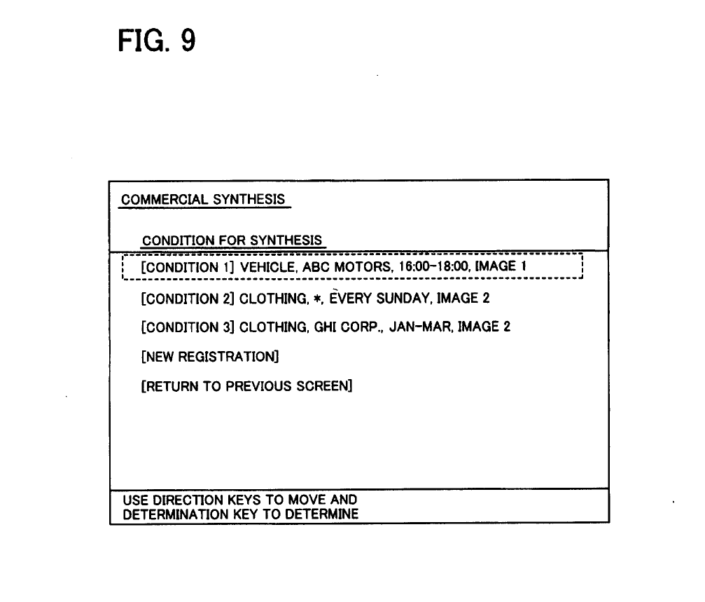

On the operation screen shown in FIG. 4, the user can set an item when the user moves the cursor by using the direction keys 32a and 32c and determines the item by depressing the determination key 33. That is, when the user selects “SYNTHESIS”, an operation screen shown in FIG. 5 appears and the user can determine whether to perform synthesis. When the user selects “IMAGE FOR SYNTHESIS”, an operation screen shown in FIG. 6 appears and the user can set an image for synthesis. When the user selects “CONDITION FOR SYNTHESIS”, an operation screen shown in FIG. 9 appears and the user can set a condition for synthesis. When the user selects “RETURN TO MENU”, the operation screen shown in FIG. 3 appears.

On the operation screen shown in FIG. 5, the user can determine whether to perform synthesis itself when the user moves the cursor by using the direction keys 32a and 32c and determines an item by depressing the determination key 33. That is, when the user selects “PERFORM SYNTHESIS”, the synthesis is performed. When the user selects “DO NOT PERFORM SYNTHESIS”, the synthesis is not performed. When the user selects “RETURN TO PREVIOUS SCREEN”, the operation screen shown in FIG. 4 appears.

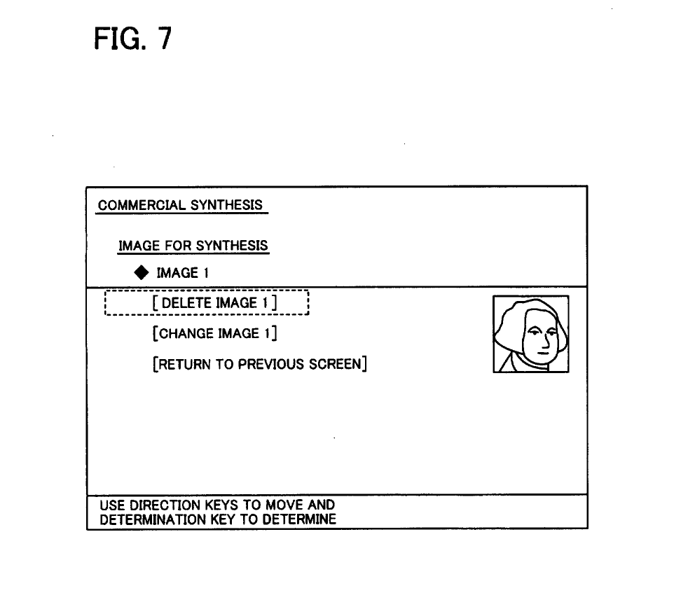

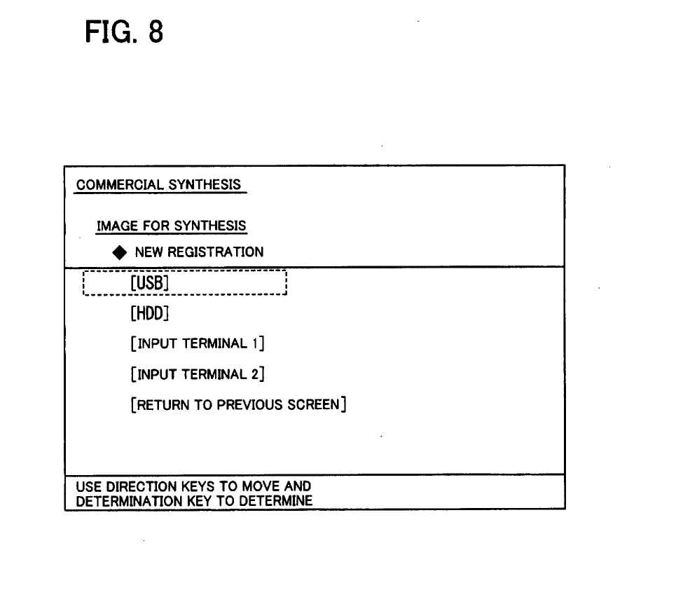

On the operation screen shown in FIG. 6, the user can set an image for synthesis when the user moves the cursor by using the direction keys 32a, 32b, 32c, and 32d and determines an item by depressing the determination key 33. That is, when the user selects “IMAGE 1”, an operation screen shown in FIG. 7 appears and the user can set the image 1. When the user selects “NEW REGISTRATION”, an operation screen shown in FIG. 8 appears and the user can register a new image. When the user selects “RETURN TO PREVIOUS SCREEN”, the operation screen shown in FIG. 4 appears.

On the operation screen shown in FIG. 7, the user can set the image 1 when the user moves the cursor by using the direction keys 32a and 32c and determines an item by depressing the determination key 33. That is, when the user selects “DELETE IMAGE 1”, the image 1 is deleted. When the user selects “CHANGE IMAGE 1”, the image 1 is changed. When the user selects “RETURN TO PREVIOUS SCREEN”, the operation screen shown in FIG. 6 appears.

On the operation screen shown in FIG. 8, the user can set a source of an image to be newly registered when the user moves the cursor by using the direction keys 32a and 32c and determines an item by depressing the determination key 33. That is, image data is inputted from the selected source. When the user selects “RETURN TO PREVIOUS SCREEN”, the operation screen shown in FIG. 6 appears. When “USB”, “INPUT TERMINAL 1”, or “INPUT TERMINAL 2” is selected, image data is inputted through the image input unit 25 and stored in the storage unit 26. When “HDD” is selected, image data stored in the storage unit 26 is used.

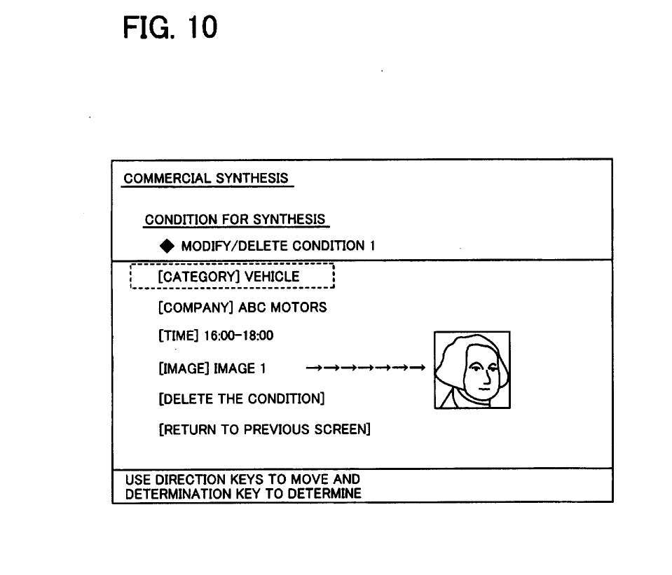

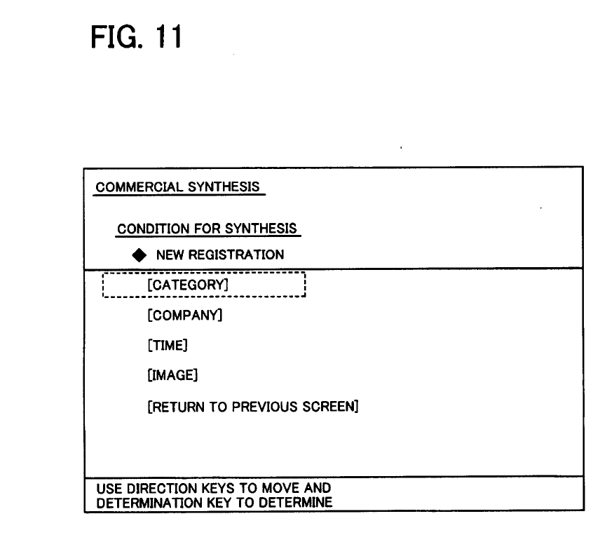

On the operation screen shown in FIG. 9, the user can set a condition for synthesis when the user moves the cursor by using the direction keys 32a and 32c and determines an item by depressing the determination key 33. That is, when the user selects “CONDITION 1”, an operation screen shown in FIG. 10 appears and the user can set the condition 1. When the user selects “NEW REGISTRATION”, an operation screen shown in FIG. 11 appears and the user can register a new condition. When the user selects “RETURN TO PREVIOUS SCREEN”, the operation screen shown in FIG. 4 appears.

On the operation screen shown in FIG. 10, the user can set the condition 1 when the user moves the cursor by using the direction keys 32a and 32c and determines an item by depressing the determination key 33. That is, when the user selects “CATEGORY”, the user can modify the category of content advertised in a commercial. When the user selects “COMPANY”, the user can modify a company advertised in a commercial. When the user selects “TIME”, the user can modify a time when a commercial is broadcast. When the user selects “IMAGE”, the user can modify the designation of an image that is used for synthesis in the case where this condition (condition 1) is satisfied. When the user selects “DELETE THE CONDITION”, the user can delete this condition (condition 1). When the user selects “RETURN TO PREVIOUS SCREEN”, the operation screen shown in FIG. 9 appears.

On the operation screen shown in FIG. 11, the user can set a condition to be newly registered when the user moves the cursor by using the direction keys 32a and 32c and determines an item by depressing the determination key 33. That is, the setting of a selected item is performed. In this screen, “CATEGORY”, “COMPANY”, “TIME”, and “IMAGE” refer to the category of content advertised in a commercial, a company advertised in a commercial, a time when a commercial is broadcast, and an image that is used for synthesis in the case where this condition (condition 1) is satisfied, respectively.

The category of content advertised in a commercial refers to, for example, a vehicle, clothing, a bank, a department store, and the like. The time when a commercial is broadcast refers to a start time, an end time, a day of the week, a month, and the like. If there is no setting of a condition, an asterisk “*” is displayed as shown in the condition 2 of FIG. 9.

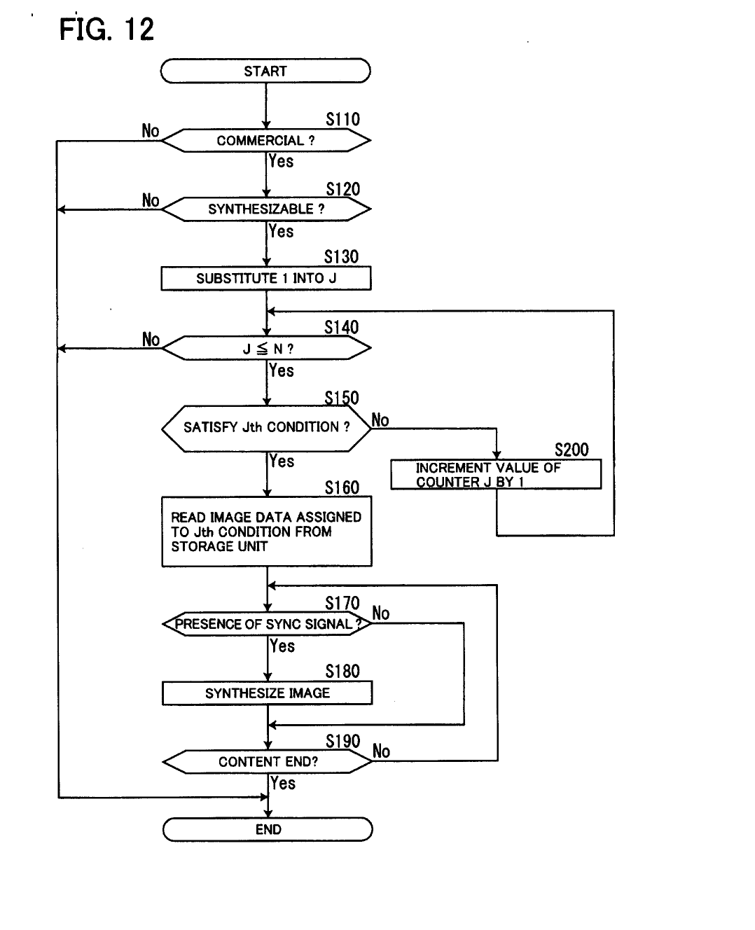

In the case where there is thus set a condition for determining whether the transmitted content is a commercial with which the image is synthesized and the setting for image synthesis is set to “PERFORM SYNTHESIS”, the processing shown by the flowchart of FIG. 12 is executed when the user views a digital broadcast. The processing is controlled by the controller 28.

In step S110, the controller 28 determines whether transmitted content is a commercial. If it is a commercial, the flow proceeds to step S120. If not, the flow proceeds to “END”. The determination as to whether the content is a commercial is made based on “content information”. The content information is transmitted in a digital broadcast, and includes the category of the content, content, a broadcast time, and synthesis permission/prohibition information.

In step S120, the controller 28 determines whether a commercial being received is synthesizable. If it is synthesizable, the flow proceeds to step S130. If not, the flow proceeds to “END”. The determination as to whether the commercial is synthesizable is made based on the content information. For example, in the case of a commercial that does not permit synthesis, a sender adds a signal signifying the prohibition of synthesis to the commercial for transmission; therefore, synthesis cannot be performed.

In step S130, the controller 28 substitutes 1 into a counter J in the controller 28, and the flow proceeds to step S140.

In step S140, the controller 28 determines whether the value of the counter J is equal to or smaller than the number of conditions N stored in the storage unit 26. If it is equal to or smaller than N, the flow proceeds to step S150. If not, the flow proceeds to “END”.

In step S150, using the content information, the controller 28 determines whether the commercial satisfies the Jth condition stored in the storage unit 26. If it satisfies the condition, the flow proceeds to step S160. If not, the flow proceeds to step S200.

In step S160, the synthesis unit 27 reads image data assigned to the Jth condition from the storage unit 26, and the flow proceeds to step S170. Since the storage unit 26 stores information for designating image data assigned for each condition, it is possible to designate the image data by using this information. For example, in the case where the image 1 is assigned to the condition 1 and the image 2 is assigned to the condition 2, “1” for the condition 1 and “2” for the condition 2 are stored as information for designating image data.

In step S170, the controller 28 determines whether a sync signal has been detected. If it has been detected, the flow proceeds to step S180. If not, the flow proceeds to step S190. The sync signal refers to a pulse signal transmitted only during a time period in which the synthesis should be performed during commercial transmission.

In step S180, the synthesis unit 27 synthesizes an image represented by the image data read from the storage unit 26 in step S160 with video represented by a video signal outputted from the decoder 22, and outputs the synthesized data. Then, the flow proceeds to step S190.

In step S190, the controller 28 determines whether the content (commercial) ends. If it ends, the flow proceeds to “END”. If not, the flow proceeds to step S170.

In step S200, the controller 28 increments the value of the counter J by 1, and the flow proceeds to step S140.

As described above, according to the invention, it is possible to provide a digital broadcast receiver capable of performing synthesis on a commercial that a user desires.

Further, the digital broadcast receiver can establish timing for synthesizing an image by discriminating sync signals described by the sender in BML (Broadcast Markup Language).

Furthermore, the content information used in several steps included in the above processing can be described in the BML in the case of MPEG2.

Furthermore, in the case of MPEG4, the sender prepares the profile of a commercial for synthesis, and the digital broadcast receiver may perform image synthesis if there is a description of synthesis permission in the profile.

In the above embodiment, the image synthesis is performed only during a period over which sync signals are detected. However, the image synthesis may be performed only during a predetermined period (e.g., 2 seconds) after a sync signal is detected, or may be performed only when a predetermined number of sync signals are detected.

It should be understood by those skilled in the art that various modifications, combinations, sub-combinations and alterations may occur depending on design requirements and other factors insofar as they are within the scope of the appended claims or the equivalents thereof.

The effects of the present invention are as follows.

According to the aspects of the invention, since a user can set a condition beforehand, it is possible to provide a digital broadcast receiver capable of synthesizing an image with a commercial that a user desires.

Further, according to the aspects of the invention, since a condition is determined by using content information, it is possible to provide a digital broadcast receiver capable of setting a more precise condition. The aspects of the invention enables image synthesis based on a sync signal and therefore can provide a digital broadcast receiver capable of performing image synthesis only during a necessary period in a commercial. The invention enables image synthesis only during a period over which sync signals are detected and therefore can provide a digital broadcast receiver capable of performing image synthesis only during a necessary period in a commercial. The aspects of the invention can set a condition concerning a company advertised, a category of content, and a broadcast time and therefore can provide a digital broadcast receiver that allows a user to easily designate a commercial.

1. A digital broadcast receiver comprising:
a receiving unit for receiving a digital signal sequence which is data of content transmitted by a digital broadcast;
a decoder for decoding the received digital signal sequence into content information, an audio signal, and a video signal;
a storage unit for storing image data;
a synthesis unit for reading image data stored in the storage unit and synthesizing an image represented by the image data with video represented by the video signal; and
a controller for controlling the receiving unit, the decoder, the storage unit, and the synthesis unit; wherein
the storage unit further stores a condition for determining whether the transmitted content is a commercial with which an image is synthesized and information for designating image data assigned for each condition;
the controller determines whether the transmitted content satisfies a condition stored in the storage unit; and
if the controller determines that the transmitted content satisfies at least one of conditions stored in the storage unit, the synthesis unit reads from the storage unit image data designated by information for designating image data assigned for a satisfied condition stored in the storage unit and synthesizes an image represented by the image data with video represented by the video signal.

2. The digital broadcast receiver according to claim 1, wherein the controller uses the content information to determine whether the transmitted content satisfies a condition stored in the storage unit.

3. The digital broadcast receiver according to claim 1, wherein
the controller detects a sync signal from the received digital signal sequence; and
if the controller determines that the transmitted content satisfies at least one of conditions stored in the storage unit, the synthesis unit reads from the storage unit image data designated by information for designating image data assigned for a satisfied condition stored in the storage unit and synthesizes an image represented by the image data with video represented by the video signal only during a period determined based on the sync signal.

4. The digital broadcast receiver according to claim 1, wherein
the controller detects a sync signal from the received digital signal sequence; and
if the controller determines that the transmitted content satisfies at least one of conditions stored in the storage unit, the synthesis unit reads from the storage unit image data designated by information for designating image data assigned for a satisfied condition stored in the storage unit and synthesizes an image represented by the image data with video represented by the video signal only during a period over which the controller detects the sync signal.

5. The digital broadcast receiver according to claim 1, wherein the condition designates a company advertised in a commercial, a category of content, and a broadcast time.

6. The digital broadcast receiver according to claim 2, wherein
the controller detects a sync signal from the received digital signal sequence; and
if the controller determines that the transmitted content satisfies at least one of conditions stored in the storage unit, the synthesis unit reads from the storage unit image data designated by information for designating image data assigned for a satisfied condition stored in the storage unit and synthesizes an image represented by the image data with video represented by the video signal only during a period determined based on the sync signal.

7. The digital broadcast receiver according to claim 2, wherein
the controller detects a sync signal from the received digital signal sequence; and
if the controller determines that the transmitted content satisfies at least one of conditions stored in the storage unit, the synthesis unit reads from the storage unit image data designated by information for designating image data assigned for a satisfied condition stored in the storage unit and synthesizes an image represented by the image data with video represented by the video signal only during a period over which the controller detects the sync signal.

8. The digital broadcast receiver according to claim 2, wherein the condition designates a company advertised in a commercial, a category of content, and a broadcast time.

9. The digital broadcast receiver according to claim 3, wherein the condition designates a company advertised in a commercial, a category of content, and a broadcast time.

10. The digital broadcast receiver according to claim 4, wherein the condition designates a company advertised in a commercial, a category of content, and a broadcast time.

11. The digital broadcast receiver according to claim 6, wherein the condition designates a company advertised in a commercial, a category of content, and a broadcast time.

12. The digital broadcast receiver according to claim 7, wherein the condition designates a company advertised in a commercial, a category of content, and a broadcast time.
